(19) United States
(12) Patent Application Publication
(10) Pub. No.: US 2017/0076321 A1
(43) Pub. Date: Mar. 16, 2017

(54) PREDICTIVE ANALYTICS IN AN AUTOMATED SALES AND MARKETING PLATFORM

(71) Applicant: ClearSlide, Inc., San Francisco, CA (US)

(72) Inventors: Deborah-Anna Reznek, Redwood City, CA (US); Ankit Jain, San Francisco, CA (US); Xuening Liu, San Francisco, CA (US); Luca Weihs, San Francisco, CA (US); Jialin Yu, San Francisco, CA (US)

(21) Appl. No.: 15/265,728

(22) Filed: Sep. 14, 2016

Related U.S. Application Data
(60) Provisional application No. 62/218,552, filed on Sep. 14, 2015.

(51) Int. Cl. G06Q 30/02

(52) U.S. Cl. CPC G06Q 30/0246; G06Q 30/0277

(57) ABSTRACT

Techniques are disclosed herein for collecting objective activity data that represents the experiences and reactions of a viewer of content shared by a sales representative. The content may include a series of slides that include information regarding a product or service pitched by the sales representative to the viewer (e.g., a prospective customer). Objective activity data indicative of viewer interactions with the content can be generated by the scripting computer language codes and automatically uploaded to an analytics platform via one or more application programming interfaces. The analytics platform can apply one or more predictive modeling techniques to the objective activity data in order to measure the actual engagement of the viewer with the content shared by the sales representative.

### CROSS-REFERENCE TO RELATED APPLICATIONS

This application claims the benefit of the following application, which is incorporated by reference in its entirety, U.S. Provisional Application No. 62/218,552, entitled “PREDICTIVE ANALYTICS IN AN AUTOMATED SALES AND MARKETING PLATFORM,” filed Sep. 14, 2015.

### COPYRIGHT NOTICE

A portion of the disclosure of this patent document contains material that is subject to copyright protection. The copyright owner has no objection to the facsimile reproduction by anyone of the patent document or the patent disclosure, as it appears in the United States Patent and Trademark Office patent files or records, but otherwise reserves all copyright rights whatsoever. The following notice applies to the software and data as described below and in the drawings that form a part of this document: Copyright 2016, ClearSlide, Inc., All Rights Reserved.

### TECHNICAL FIELD

The present disclosure relates to analyzing viewer interactions with shared content and, more specifically, to collecting and processing viewer activity data to measure the quantity and quality of interactions.

### BACKGROUND

Business analytics refers to the technologies and processes used to investigate past performance to gain insight into business practices and drive business planning. Business analytics focuses on developing new insights and an improved understanding of these business practices based on data and statistical methods (e.g., explanatory and predictive modeling). Sales leaders generally attempt to harness data in order to influence customers to spend more and make purchases more quickly, influence logistics networks to perform more efficiently, etc. Said another way, sales leaders often employ business analytics to improve sales forecasting and the outcomes of sales interactions between sales representatives and prospective buyers.

Sales forecasting, however, has traditionally been an inexact science. In fact, research has shown that nearly 66% of sales representatives fail to achieve quota targets and that less than 10% of sales leaders have high confidence in current sales forecasts. Low sales forecasting accuracy can be attributed to several factors, including inaccurate summarizations of the interactions between sales representatives and prospective customers, inaccurate recording of sales activity, and the experience of prospective buyers throughout the sales process.

But the impact of these human interactions on the sales process as a whole remains difficult to quantify and analyze. For example, in order to increase the likelihood a prospective buyer purchases a product pitched by a sales representative, the sales representative may collect and analyze information related to the product's functionality, color, size, and weight. Note, however, that this type of analysis will remain incomplete so long as it does not measure the prospective buyer's actual experience throughout the sales process (e.g., the reaction and rapport with the sales representative, whether questions were answered promptly and appropriately, whether the prospective buyer is in a hurry).

Existing sales forecasting techniques attempt to quantify these immeasurable attributes by asking sales representatives or prospective buyers for their opinions directly (e.g., through surveys and questionnaires or an analysis of open-ended comments). But the accuracy of such sales forecasting techniques remains hampered due to the subjectivity of the information collected from the sales representatives or the prospective buyers.

### BRIEF DESCRIPTION OF DRAWINGS

Various objects, features, and characteristics will become apparent to those skilled in the art from a study of the Detailed Description in conjunction with the appended claims and drawings, all of which form a part of this specification. While the accompanying drawings include illustrations of various embodiments, the drawings are not intended to limit the claimed subject matter.

FIG. 1 depicts a diagram of an environment including a system within which the present embodiments may be implemented.

FIG. 2 depicts a diagram of an environment that includes an analytics platform and a user device (e.g., a mobile phone, tablet, or personal computer) on which a viewer views content shared by a sales representative.

FIG. 3 depicts a method for acquiring, aggregating, and analyzing objective activity data related to viewer interactions with content shared by a sales representative.

FIG. 4A depicts one example of a predictive insight dashboard that may be generated by the analytics platform.

FIG. 4B depicts another example of a predictive insight dashboard that may be generated by the analytics platform.

FIG. 5 is a block diagram illustrating an example of a processing system in which at least some operations described herein can be implemented.

The figures depict various embodiments described throughout the Detailed Description for the purposes of illustration only. The same or similar reference numbers may be used to identify elements having the same or similar structure or functionality throughout the drawings and specification for ease of understanding and convenience. While specific embodiments have been shown by way of example in the drawings and are described in detail below, the invention is amenable to various modifications and alternative forms. The intention is not to limit the invention to the particular embodiments described herein. Accordingly, the claimed subject matter is intended to cover all modifications, equivalents, and alternatives falling within the scope of the invention as defined by the appended claims.

### DETAILED DESCRIPTION

Techniques are disclosed herein for collecting objective activity data that represents the experiences and reactions of a viewer of content shared by a sales representative. The content may include a series of slides that include information regarding a product or service pitched by the sales representative to the viewer (e.g., a prospective customer). The content can be shared, for example, via a browser-based screen sharing technology that uses scripting computer languages codes to detect instances of viewer activity. Accordingly, the slides may be presented to the viewer on a webpage in a web browser accessed on user device (e.g., a mobile phone, tablet, or personal computer).

Objective activity data indicative of viewer interactions with the content can be generated by the scripting computer language codes and automatically uploaded to an analytics platform via one or more application programming interfaces (APIs). The analytics platform may be part of a sales and marketing platform managed by a sales engagement entity. The analytics platform can apply predictive modeling techniques to the objective activity data in order to measure the actual engagement of the viewer with the content shared by the sales representative.

Predictive modeling techniques generally fall into two categories, supervised learning and unsupervised learning. In supervised learning, a historical data set with known historical outcomes is used to discover the patterns between predictor data and the outcomes. For example, applying supervised learning techniques to a historical data set may show a more positive bias in the number of calls made by a sales representative to a prospective customer than in the number of in-person meetings between the sales representative and the prospective customer. As another example, the analytics platform may use a historical data set of past deals to predict whether future deals are likely to close. The prediction of likelihood (also referred to as a “confidence score”) is often expressed as a number between 0 and 100, but it could also be expressed in several other ways (e.g., red/yellow/green or “yes, likely to close” versus “no, not likely to close”). Known classification techniques may be used, such as logistic regression, random forest, support vector machines, etc. Additionally or alternatively, continuous outcomes (e.g., the revenue associated with ongoing deals) can be predicted using regression analysis or related techniques.

Unsupervised learning, meanwhile, may be used to assign confidence scores to potential deals, thereby indicating the level of customer engagement on those deals. More specifically, patterns among the deals themselves could be used to create the confidence scores. For example, clustering analysis can be used to create groups of deals that show similar patterns in how the prospective customers engaged with the shared content on those deals. As another example, heuristic analysis may be used to discover “tipping points” that specify where important changes in customer engagement occur.

Among other benefits, some embodiments provided herein enable more accurate measuring of the quantity and quality of interactions between sales representatives and viewers of shared content (e.g., prospective buyers of a product or service). Sales forecasting accuracy can be improved because the analytics platform considers objective information automatically derived from sales interactions, rather than subjective information provided by the sales representatives and/or the viewers. Moreover, some embodiments provided herein enable the objective activity data to be automatically collected without requiring additional software applications or plugins be installed by the viewer prior to viewing the content.

### TERMINOLOGY

Brief definitions of terms, abbreviations, and phrases used throughout the Detailed Description are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Overview

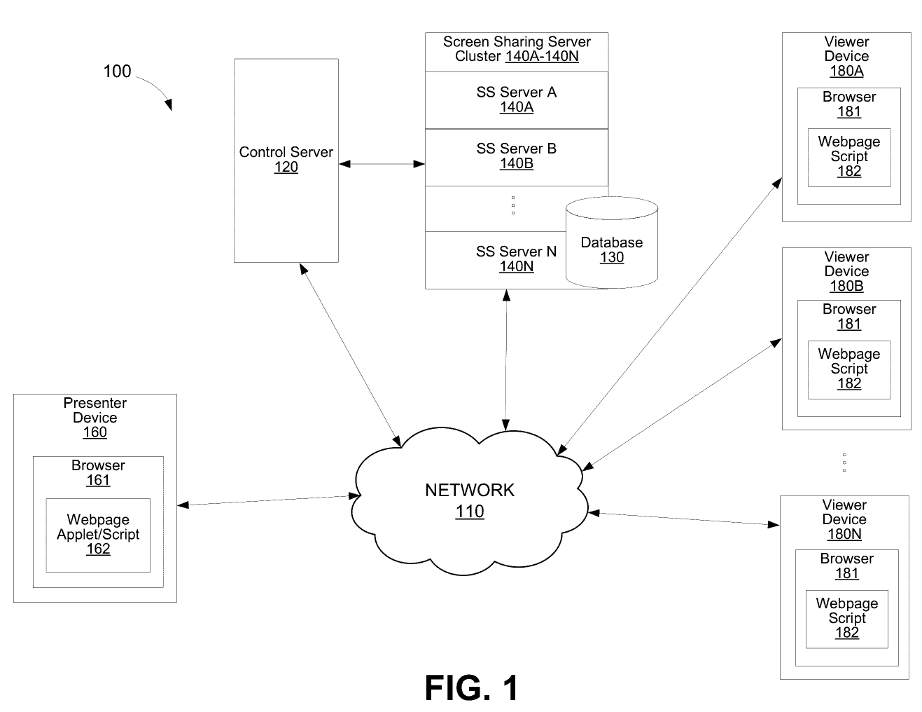

FIG. 1 depicts a diagram of an environment including a system 100 within which the present embodiments may be implemented. The system 100 includes a presenter (e.g., a sales representative) operating a presenter device 160, one or more viewers operating viewer devices 180A-180N, a screen sharing server 140 (which is collectively represented by a screen sharing cluster 140A-140N, and optionally in some embodiments, a presentation control server 120), and a network 110.

The viewer devices 180 and the presenter device 160 can be any system and/or device, and/or any combination of devices/systems that is able to establish a connection, including wired, wireless, and cellular connections with another device, a server, and/or other systems such as the screen sharing server 140. The viewer devices 180 and the presenter device 160 typically include a display and/or other output functionalities to present information and data exchanged between or among the devices 180, 160 and/or the screen sharing server 140. In one embodiment, there is only a single screen sharing server 140. In one or more embodiments, there are multiple screen sharing servers 140 operating collectively or independently, such as the screen sharing server cluster 140A-140N illustrated in FIG. 1.

The viewer devices 180 and the presenter device 160 may include computing devices such as mobile (or portable) devices or non-portable devices. Non-portable devices can include a desktop computer, a computer server, or cluster. Portable devices can including a laptop computer, a mobile phone, a smart phone, a personal digital assistant (PDA), a handheld tablet computer, or a combination thereof. Typical input mechanisms on the viewer devices 180 and the presenter device 160 can include a touch screen display (including a single-touch (e.g., resistive) type or a multi-touch (e.g., capacitive) type), gesture control sensors (e.g., for 2D or 3D gesture sensing), a physical keypad, a mouse, motion detectors (e.g., including 1-axis, t-axis, 3-axis accelerometer, etc.), light sensors, temperature sensor, proximity sensor, device orientation detector (e.g., electronic compass, gyroscope, or GPS), and so forth. Note that those skilled in the art will be familiar with the computer systems suitable for use in implanting servers and user devices.

In one example, the viewer devices 180, screen sharing server 140, and presenter's device 160 are coupled via the network 110. In some other examples, the viewer devices 180, the presenter device 160, and screen sharing server 140 may be directly connected to one another.

In those embodiments with the presentation control server 120, the presentation control server 120 sets up an environment for the screen sharing. For example, the presentation control server 120 can give a presenter the tools to navigate through a series of slides, and then, when the presenter reaches a screen sharing slide, display the appropriate web pages to the presenter and viewers. The presentation control server 120 can also act as a load balancer. In this case, the presentation control server 120 can consider the geographic and/or network locations of the presenters, viewers, and sharing servers and the current load of each sharing server, and then pick the best sharing server (e.g., among the screen sharing server cluster 140A-140N) to use in order to minimize transmission distance while also distributing the load. In one example, the presentation control server 120 acts as a central sever that determines to which of the screen sharing servers 140A-140N the server 120 should direct a given screen sharing session. Afterwards, the designated shared server (e.g., SS server 140A) will act as the intermediate component between the presenter device 160 and the viewer devices 180 for performing screen sharing.

As mentioned above, the presentation control server 120 is an optional component. Screen sharing can be implemented without a separate control server (e.g., if screen sharing is not operating in the context of a larger presentation). That is, the presentation control server 120 can be useful for setting up the context in which the screen sharing operates but is not necessary. Alternatively, the functionality of the presentation control server 120 can be implemented on the presenter sharing server 140, the presenter device 160, or distributed across several different systems.

The system 100 supports screen sharing of a presenter's screen on the presenter device 160 via the network 110 and the screen sharing server 140 to one or more viewers operating viewer devices 180A-180N, regardless of whether one or more typically required plugins (e.g., a Java plugin) are installed on viewers' browsers 181. Such technique is described in greater detail in U.S. patent application Ser. No. 12/756,110, filed Apr. 7, 2010, entitled “MIXED CONTENT TYPE PRESENTATION SYSTEM,” which is incorporated by reference herein.

The presenter device 160 and the viewer devices 180 should each be capable of running a web browser 161, 181. The viewer device web browser 181 is used by the viewer operating the viewer device 180 to access a uniform resource locator (URL) to gain access to a viewer's page, which includes webpage scripts 182 (e.g., Java scripts) that can download a series of images (e.g., from the screen sharing servers 140) of a shared screen of the presenter's device 160 for the viewers to view. The webpage scripts 182 (e.g., Javascripts) can also enable the viewers to perform a variety of functions (e.g., interacting with the presenter). For example, some embodiments of the webpage script 182 embedded in the viewer's page can detect input or control events made by the viewer's input mechanism, such as mouse movements, clicks, mouse wheel rotations, or keyboard strokes, and sends the control events to the server 140.

Generally speaking, the applet or script 162 enables (through execution by the presenter's browser 161 on the presentation device 160) the presenter to control live presentations, share screens, or otherwise interact with the viewer. In some embodiments, the presenter may be asked to run an applet on the presentation device 160. For example, a screen sharing webpage containing a sharing applet or an embedded applet (e.g., a Java applet) could be loaded in the web browser 161 running on the presenter device 160. The applet contains the software code that can capture screenshots of the presenter's screen and upload the screenshots to the screen sharing servers 140, so that screens can be shared with viewers who access the provided viewer URL. Running such an applet may require permission and installation of a plug-in (e.g., a Java plug-in) software with the presenter's browser 161 on the presenter's device 160. Also, operating the plug-in software creates a process or thread (e.g., a Java Virtual Machine (JVM)) that is separate from the presenter's web browser 161 on the presenter device 160. As such, some other embodiments of the present disclosure may utilize screen sharing technologies that use only scripting computer language codes that are directly executable by the presenter's web browser 161. In other words, in the embodiments that only use scripts, the presenter can use a stock web browser, without installing any plug-in software, to perform screen sharing functionalities with the viewer devices 180 via the screen sharing server 140.

As shown in FIG. 1, in some embodiments the presenter's browser 164 need not have a webpage applet (e.g., a Java applet) installed. Additionally or alternatively, the presenter's browser 161 can execute a webpage script 162 that includes scripting computer languages codes that enable screen sharing functionalities. For example, the presenter's web browser 161 may be capable of performing plug-in-free real-time communication (RTC) with another browser. Examples of such capability include WebRTC, CU-RTC-WEB, and so forth. Overall, these techniques can utilize the presenter's web browser's built-in capability so as to reduce or completely remove the need of the webpage applet.

For purposes of discussion herein, a webpage script (e.g., Javascript) means a piece of software code that is written in scripting computer programming language, which can be directly executed (e.g., without being compiled by a compiler first) by a web browser. A scripting language is most commonly used and implemented as client-side scripts to facilitate interaction with the user, control the browser, communicate asynchronously, alter the document content that is displayed, and so forth. A person skilled in the art will understand that it typically only takes an interpreter (e.g., a software application such as a web browser) to directly execute (i.e., perform) instructions written in a programming or scripting language, without previously compiling them into a machine language program.

A person skilled in the art will also recognize that the techniques described above can be used to share content (e.g., a series of slides) with viewers and monitor viewer engagement during both synchronous and asynchronous interactions. In an asynchronous interaction, a sales representative (also referred to as a “presenter”) sends content to a viewer that can be viewed at any time (e.g., without the sales representative being present). In a synchronous interaction, the sales representative and the viewer view the content at the same time.

### Predictive Analytics and Third-Party Data Integration

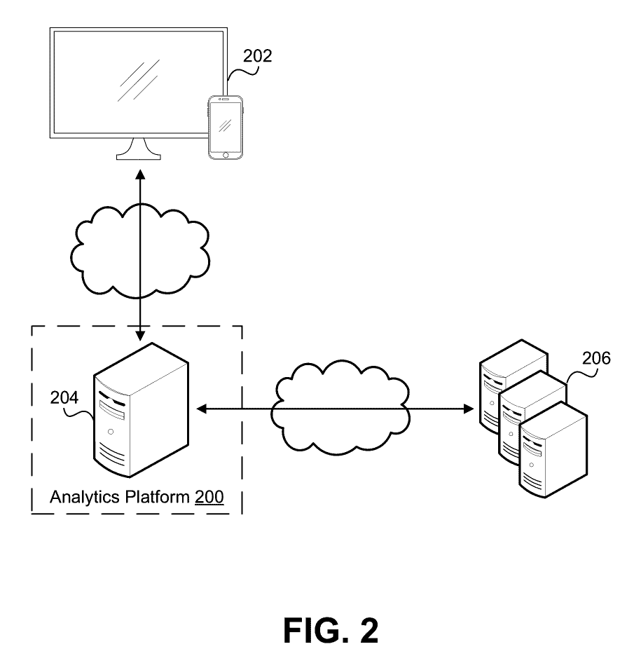

FIG. 2 depicts a diagram of an environment that includes an analytics platform 200 and a user device 202 (e.g., a mobile phone, tablet, or personal computer) on which a viewer views content shared by a sales representative. The analytics platform 200 and the user device 202 are each connected to one or more computer networks, which may include local area networks (LANs), wide area networks (WANs), metropolitan area networks (MANs), cellular networks, and/or the Internet.

Various system architectures could be used to build the analytics platform 200. Accordingly, the content may be viewable by the viewer through one or more of a web browser, software program, mobile application, and over-the-top (OTT) application. The analytics platform 200 may be executed by cloud computing services operated by, for example, Amazon Web Services (AWS) or a similar technology. Oftentimes, a host server 204 is responsible for supporting the analytics platform 200 and generating interfaces (e.g., predictive analytics dashboards) that can be used by sales leaders and/or sales representatives to monitor viewer engagement. The host server 204 may be communicatively coupled (e.g., across a network) to one or more servers 206 that include content (e.g., presentations on products or services) and other assets (e.g., objective activity data uploaded by user devices and predictive analytics profiles generated by the analytics platform 200 for certain viewers, sales representatives, etc.). The content may be hosted on the host server 204, the server(s) 206, or distributed across both the host server 204 and the server(s) 206. Moreover, in some embodiments the content is stored in a proprietary file format as a series of slides or as portions of slides.

Generally, the analytics platform 200 is responsible for presenting content to a viewer via a synchronous or asynchronous interaction. For example, a presentation that includes a series of slides may be delivered to the user device 202 as a Hyper Text Markup Language (HTML) link embedded within an electronic communication, such as an email, text message, etc. Selecting the link allows the viewer to view the content on the user device 202. The viewer can interact with the content by moving through the slides, viewing the content for a certain duration, and choosing the pace at which to move from one slide to another. For example, the viewer may choose to move forwards or backwards through the series of slides or skip forwards or backwards through the series of slides, thereby missing some slides altogether.

Viewer interactions with the content can be detected and recorded by scripting computer language codes and/or one or more application programming interfaces (APIs) that are executed by the medium through which the content is viewed (e.g., a web browser, software program, or application). For example, the start time and end time of viewing a certain element of content (e.g., a particular slide or portion of a slide) can be recorded by sending a request to an API associated with analytics platform 200. As another example, the API can detect whether a given slide is viewable and in focus (i.e., not minimized) on the display of the user device 202. Other examples of relevant viewer activities include repeat visits to the same slide, repeat visits to the same presentation, forwarding the presentation to other viewers, the time and day of asynchronous access, etc. These instances of viewer activity can be used by the analytics platform 200 to measure the engagement of the viewer. Such measurements can be calculated periodically or continually in real time (i.e., as the events occur). Moreover, the instances of viewer activity can be sent to the analytics platform 200 in the form of objective activity data using the same API or a different API.

After receiving the objective activity data from the user device 202, the analytics platform 200 can store the objective activity data in a database. The database may be maintained by the host server 204 and/or the content server(s) 206. In some embodiments, the objective activity data is stored in the database in a structure that is implied by the structure of the content itself. For example, the objective activity data could be stored by the analytics platform 200 on a slide-by-slide basis. As further described below, the objective activity data can be further processed to provide insights into the viewer's level of engagement and interest in the product or service being pitched by the sales representative. The objective activity data for similar content (e.g., presentations for similar products or presentations having a similar length or theme) could also be considered.

Thus, the analytics platform 200 can track how sales representatives are engaging with viewers by analyzing the volume and cadence of presentations, what type of content is being shared, slide-level engagement analytics, the number of electronic communications (e.g., phone calls, emails, and text messages) sent and the open rate for those electronic communications, and other criteria that may be critical to understanding whether the sales representatives are gaining traction with the viewers. More specifically, the analytics platform 200 can apply one or more predictive models or classification algorithms on the objective activity data uploaded by the user device 202 (and, in some embodiments, data retrieved from a third-party service, such as Salesforce™) to deliver a “confidence score” for each interaction between a sales representative and a viewer (i.e., for each sales opportunity in the pipeline). The confidence score specifies how likely a given interaction is to result in a sale of the product or service being pitched by the sales representative. Confidence scores generated by the analytics platform 200 provide sales leaders and sales representatives with an indication as to which interactions are on track (i.e., are likely to culminate in a sale) and which interactions are at risk of failing to culminate in a sale.

As noted above, various classification techniques (e.g., using supervised and/or unsupervised learning) can be used to calculate the confidence scores that indicate the likelihood of an interaction culminating in a sale. For example, a historical data set that includes information on outcome(s) and human interaction(s) can be acquired by the analytics platform 200. Candidate predictor variables can be derived from the information on human interaction(s). For example, raw objective activity data on human interactions (e.g., with the slides of a presentation) can be analyzed to calculate one or more variables, such as the total view time, the time spent skipping between slides, the time during which there was more than one viewer, etc. Classification techniques are applied to find the relationship between these predictor variable(s) and the outcome(s) specified by the historical data set. The analytics platform 200 may use this relationship to calculate the likelihood of future outcomes based on objective activity data uploaded to the analytics platform 200.

When used to improve sales and marketing, the analytics platform 200 can enable valuable, genuine business conversations and allows sales representatives to more consistently achieve better business outcomes. The analytics platform 200 also improves communications (e.g., via phone, email, or face-to-face) with prospective customers by providing real-time visibility and analytics for those sales representatives who drive sales and marketing. As a result, prospective customers can achieve higher seller productivity, increased sales management effectiveness, and stronger interactions with sales representatives.

In addition to the screen sharing functionalities described above, the analytics platform 200 can provide sales leaders and marketing leaders insight into the real-time activities of sales representatives and enable deep analytics regarding the type(s) of content that are most impactful with potential customers. For example, sales leaders may identify those sales representatives who are most successful in converting interactions with prospective customers into sales, and then teach the techniques used by those sales representatives to other sales representatives. For sales representatives, the analytics platform 200 can facilitate communication with prospective customers, whether online or in-person, via web browsers, mobile applications, etc.

### Methodology

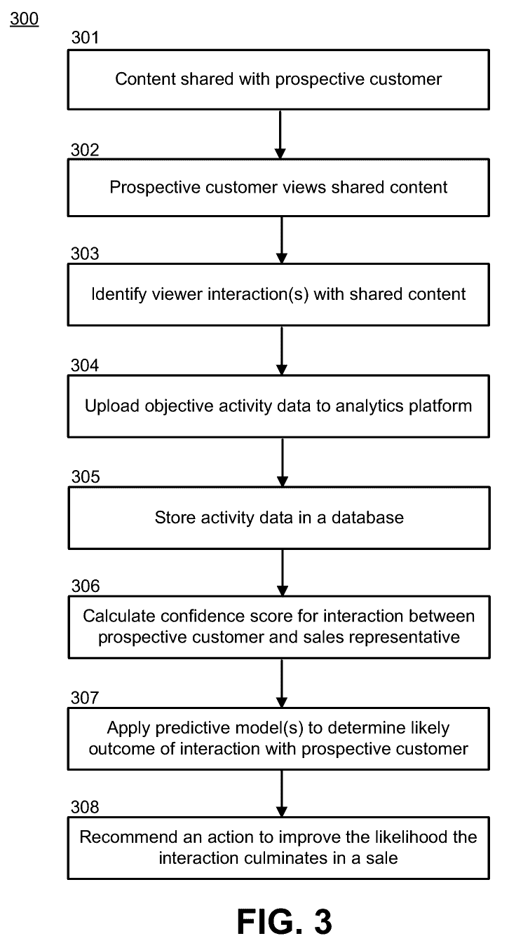

FIG. 3 depicts a method 300 for acquiring, aggregating, and analyzing objective activity data related to viewer interactions with content shared by a sales representative. Successful implementation of the techniques described herein enables the quantity and quality of these viewer interactions to be more accurately measured. The objective activity data can also be used to improve the accuracy and reliability of sales forecasts because the sales forecasts need not rely on subjective information provided by the sales representative.

Content is initially shared by a sales representative with a prospective customer (step 301). The content could include, for example, a series of slides that include information regarding a product or service the prospective customer has an interest in. In some embodiments, the sales representative shares the content by sending the prospective customer a hyperlink embedded with an address to the content, which is hosted on a computing device (e.g., a server) managed by the sales representative or a sales engagement entity. The prospective customer can then view the shared content (step 302), thereby becoming a viewer. For example, the prospective customer may select the hyperlink that is delivered via an electronic communication (e.g., an email or text message).

Viewer interactions with the shared content can be automatically identified (step 303). For example, viewer interactions (e.g., selection of certain elements of a presentation, viewing duration, view count) can be recorded by scripting computer language codes and/or APIs executed by the user device on which the viewer views the shared content. Objective activity data representing the identified viewer interactions can then be automatically uploaded to an analytics platform (step 304). Automated collection of the objective activity data by the analytics platform enables accurate prediction of sales performance by the sales representative and eliminates subjective human bias from the sales activity data used to forecast sales. For example, the analytics platform can record occurrences of sales emails, calls, and meetings as they occur, rather than require the sales representative log such events manually. The analytics platform can also log the total time spent performing each of these events, the total number of viewers who view a presentation, and other signals of viewer engagement (e.g., the amount of time spent per slide, the degree of slide repetition, the order in which slide are viewed, and the degree of viewer distraction).

In some embodiments, some or all of the objective activity data is stored by the analytics platform in a database (step 305). The objective activity data may be stored in the database in a structure that is implied by the structure of the content itself. For example, the objective activity data could be stored by the analytics platform on a slide-by-slide basis.

The analytics platform can calculate a confidence score for the interaction between the sales representative and the prospective customer (step 306). The confidence score provides the sales representative (or a sales leader) an indication as to whether the interaction is on track to culminate in a sale. The analytics platform may also apply one or more predictive models to determine the likely outcome of the interaction between the sales representative and the prospective customer (step 307).

Because the objective activity data does not include the subjective views of the prospective customer or the sales representative, the analytics platform can process the unbiased objective activity data to make more accurate sales predictions. Consequently, the analytics platform can identify strong predictors and/or weak predictors of viewer engagement (and thus revenue outcomes). These predictors may consider measurements made across a wide set of viewers. That is, the predictors may not be limited to the isolated activities of a single viewer and a single sales representative. In some embodiments, statistical methods (e.g., supervised machine learning techniques) can be used to improve the predictive models over time as the analytics platform collects additional objective activity data, identifies strong predictors, calibrates the importance of previously-identified predictors, etc.

In some embodiments, the analytics platform recommends an action to improve the likelihood that the interaction between the sales representative and the viewer culminates in a sale (step 308). For example, the analytics platform may recommend the sales representative begin communicating with the viewer over the phone rather than via email, increase the frequency of communications, etc. The analytics platform could also flag those interactions that are unlikely to culminate in a sale (and thus should be given lower priority by the sales representative). As noted above, the predictors can also be used to improve the performance of other sales representatives (e.g., by teaching other sales representatives which predictors/factors are highly relevant to completing a sale).

The techniques introduced here empower sales leaders and sales representatives to forecast sales with confidence because the predicted outcome of a given interaction with a prospective customer is based on actual engagement data generated during online (e.g., synchronous) or offline (e.g., asynchronous) presentations. The revenue expected from ongoing interactions (i.e., existing sales opportunities) can also be more accurately predicted. Examples of questions that may be answered by the analytics platform based on the objective activity data include:
How likely is a given deal to culminate in a sale?
Which deals may culminate in a sale and require the most attention? Which deals are unlikely to culminate in a sale and deserve the least attention?
Which sales metrics correlate to successful interactions with prospective customers?
Which content (or type of content) drives the most sales?
Which business practices increase close rate?
How much revenue should be projected for a given timeframe?
Are certain sales tactics more effective for certain customer segments?

### Predictive Insights Dashboard

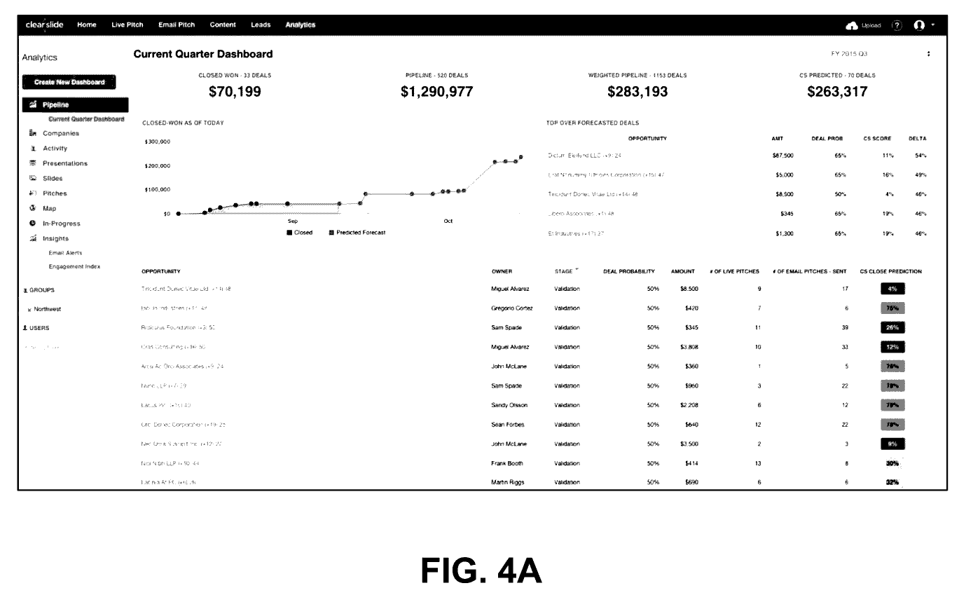

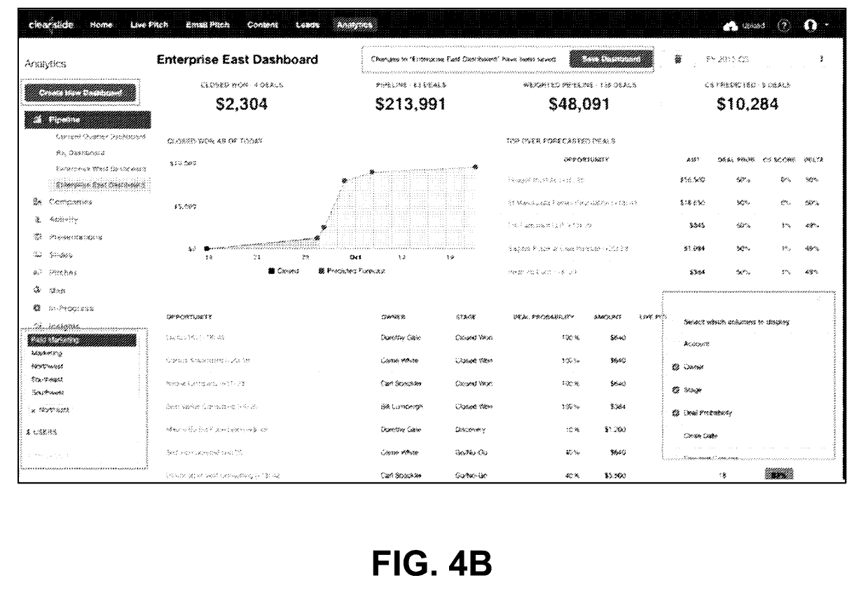

FIGS. 4A-B depict several examples of predictive insight dashboards that may be generated by the analytics platform. The dashboards may be generated by the analytics platform after applying one or more data science processing techniques to the objective activity data uploaded by the user device(s) of one or more viewers of content shared by a sales representative. Accordingly, the dashboards provide unprecedented insight into ongoing interactions between the sales representative and the prospective customer(s), thereby giving sales leaders more accurate and reliable understanding of ongoing interactions. Each of these interactions represents an opportunity within the sales pipeline. Sales leaders and sales representatives can use these dashboards to more accurately forecast future sales, take appropriate action to affect the outcome of an interaction with a given prospective customer, improve the effectiveness of sales representatives, etc.

Sales leaders and sales representatives increasingly rely on predictive analytics to synthesize sales data, optimize operations, and improve decision making during the sales process. The predictive insights dashboards shown here can improve confidence in sales forecasting by establishing predictive insights profiles for certain prospective customers, sales representatives, products or services, etc. Some or all of the potential sales in the pipeline can then be scored (e.g., with a confidence score) using machine learning models that analyze multiple attributes that predict successful outcomes. For example, in some embodiments over 150 different attributes are considered. Some of these attributes may be tagged as strong predictors (i.e., highly relevant to making a sale), while other attributes are tagged as weak predictors (i.e., less relevant to making a sale). One skilled in the art will recognize that predictive models may consider any number of predictors regardless of relevance to making a sale. Moreover, the number of predictors considered when predicting the outcome of an interaction may vary over time. For example, the analytics platform may discover additional strong predictors over time, and then add those strong predictors to the predictive model(s).

The dashboards can also be used to track how sales representatives are engaging with prospective customers over time. For example, the dashboards may specify the volume and cadence of presentations, what content has been shared, slide-level engagement analytics, the number of electronic communications (e.g., phone calls, emails, and text messages) that have been sent and the open rate for those electronic communications, and other criteria that may be critical to understanding whether the sales representatives are gaining traction with prospective customers. These factors (and the relevance of these factors) can be shown on the dashboards and, in some embodiments, are updated in real time as additional objective activity data is collected by the analytics platform.

As noted above, the analytics platform can apply the objective activity data to one or more predictive models on the objective activity data to deliver a “confidence score” for each interaction between a sales representative and a viewer (i.e., for each sales opportunity in the pipeline). The confidence score specifies how likely a given interaction is to result in a sale of the product or service being described by the shared content. The confidence scores provide sales leaders with an indication as to which interactions are on track and which interactions are at risk of failing to culminate in a sale. The predictive model(s) utilize data science processing techniques that benefit from the aforementioned customer engagement analytics from presentations of shared content and other activities facilitated by the analytics platform. In some embodiments, the analytics platform also collects third-party customer relationship management (CRM) data (e.g., from Salesforce™). The dashboards may allow a sales leader or sales representative to easily retrieve third-party CRM data form such sources.

As shown in FIGS. 4A-B, the predictive insights dashboards provide a tool for sales leaders and/or sales representatives to better understand the objective activity data and/or the third-party CRM data collected by the analytics platform. For example, the dashboards may identify those interactions that are most likely to culminate in a sale and those interactions that require additional involvement by the sales representative. Sales leaders and sales representatives can access and quickly customize these interactive dashboards to better understand the status of ongoing interactions with prospective customers or filter by group, individual, product or service, etc.

In some embodiments, the analytics platform employs its predictive insights functionality to instantly highlight forecasted deals having high confidence scores (i.e., deals that are likely to close) or forecasted deals having low confidence scores (i.e., deals that are at risk and are unlikely to close). For example, if a given interaction has a customer relationship management (CRM) deal probability of 80 percent and a confidence score of 25 percent (as calculated using the predictive analytics techniques introduced here), then a sales leader can work with the corresponding sales representative(s) to identify the gap between actual buyer engagement and self-reported pipeline probability.

Predictive analytics that employ machine learning models and/or integrate with third-party intelligence (e.g., provided by Salesforce™) allow the dashboards to serve as a powerful way to illustrate key aspects of the sales process. For example, the dashboards can be used to monitor which sales representatives have the highest levels of prospective customer engagement, which interactions are candidates for potential sales, whether a given potential sale is likely to close, etc. Moreover, information learned by the sales leader and the sales representatives can be used to improve subsequent interactions with prospective customers. For example, a sales leader may discover which sales representatives or sales techniques are most effective in closing deals by reviewing the objective activity data shown by the dashboards, and then use that information to improve the outcomes of interactions by other sales representatives.

The dashboards also enable sales leaders and sales representatives to visualize objective activity data uploaded by the user device of a prospective customer who views shared content and ascertain customer engagement across different channels. Note that this can cover engagement with prospective customers and existing customers, regardless of whether those customers are engaged via live online pitches or emailed pitches that track which prospective customers have viewed linked content. The dashboards may augment a sales forecast with those deals that are most likely to succeed and those deals that require direct engagement with the corresponding prospective customer.

In some embodiments, the dashboards allow the analytics platform to be readily integrated with a third-party service (e.g., Salesforce™) using one or more APIs (e.g., a Salesforce API) to generate activity records, populate fields on the activity records to capture additional information, and optionally create contacts and leads that can be used by a sales representative. For example, the dashboards may include dropdown menus that allow the sales representative to easily specify which third-party service(s) should be connected to the analytics platform. Sales representatives may also be able to select which prospective customer(s) receive an invitation to view shared content via a dropdown menu within the dashboards, which allows manual logging of sales activities to be completed quickly and easily.

Integration with one or more third-party services may make it easier for sales representatives to log activities performed through the analytics platform. For example, sales representatives may specify how much time is spent presenting to prospective customers, which emails are opened, which presentations are viewed, etc. More specifically, in some embodiments the analytics platform provides one or more buttons in a third-party website (e.g., a Salesforce™ interface) that allow users of the third-party website (e.g., sales leaders and sales representatives) to immediately launch a presentation that is enabled by the analytics platform. Integration also enables the analytics platform to push objective activity data (also referred to as “viewer engagement data”) into a Salesforce™ environment for further processing. The analytics platform can use the objective activity data collected from the user device of a prospective customer and the third-party CRM data to answer questions related to sales performance, such as how long a sales representative has traditionally spent engaging prospective customers who become purchasers, how often purchasers viewed content shared by the sales representative, etc.

### Processing System

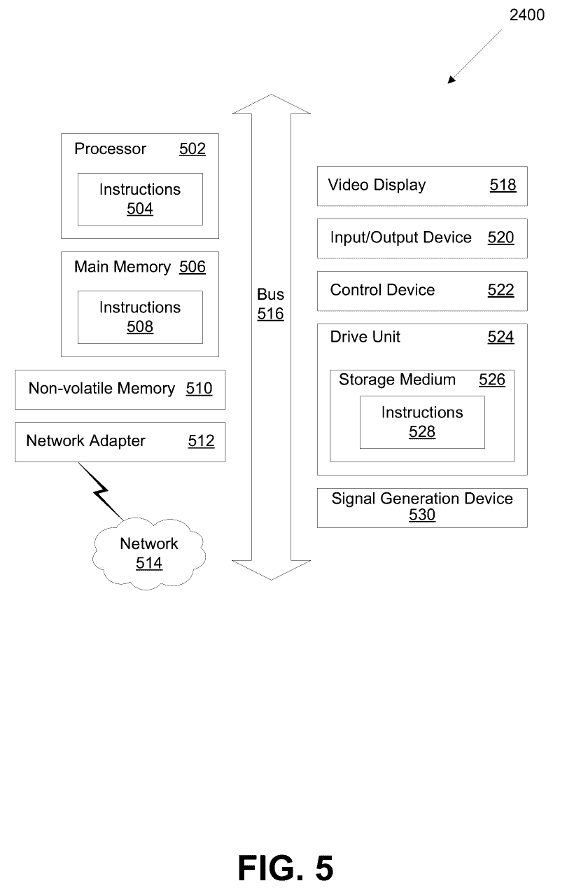

FIG. 5 is a block diagram illustrating an example of a processing system 500 in which at least some operations described herein can be implemented. The processing system 500 can represent any of the devices described above, such as the presenter device 160, the control server 120, one or more of the presentation servers in the screen sharing server cluster 140A-140N, the viewer devices 180A-N, or the host server 204. As noted above, any of these systems may include two or more subsystems or devices, which may be coupled to each other via one or more networks.

The processing system may include one or more central processing units (“processors”) 502, main memory 506, non-volatile memory 510, network adapter 512 (e.g., network interfaces), video display 518, input/output devices 520, control device 522 (e.g., keyboard and pointing devices), drive unit 524 including a storage medium 526, and signal generation device 530 that are communicatively connected to a bus 516. The bus 516 is illustrated as an abstraction that represents any one or more separate physical buses, point to point connections, or both connected by appropriate bridges, adapters, or controllers. The bus 516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 500 operates as a standalone device, although the processing system 500 may be connected (e.g., wired or wirelessly) to other machines. In a networked deployment, the processing system 500 may operate in the capacity of a server or a client machine in a client-server network environment, or as a peer machine in a peer-to-peer (or distributed) network environment.

The processing system 500 may be a server computer, a client computer, a personal computer (PC), a user device, a tablet (e.g., an Apple iPad), a laptop computer, a personal digital assistant (PDA), a mobile phone (e.g., an Apple iPhone), a processor, a telephone, a web appliance, a network router, switch, or bridge, a console, a hand-held console, a (hand-held) gaming device, a music player, a network-connected wearable device (e.g., a watch), or any machine capable of executing a set of instructions (sequential or otherwise) that specify actions to be taken by the computing system.

While the main memory 506, non-volatile memory 510, and storage medium 526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 528. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 504, 508, 528) set at various times in various memory and storage devices in a computer, and that, when read and executed by one or more processing units or processors 502, cause the processing system 500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 510, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 512 enables the computing system 500 to mediate data in a network 514 with an entity that is external to the computing device 500, through any known and/or convenient communications protocol supported by the processing system 500 and the external entity. The network adapter 512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 512 can include a firewall that can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Remarks

Unless contrary to physical possibility, it is envisioned that (i) the techniques and steps described above may be performed in any sequence or in any combination, and that (ii) the components of respective embodiments may be combined in any manner.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A computer-implemented method comprising:
creating a hyperlink embedded with an address to content that describes a product or a service;
sending the hyperlink to a user device associated with a viewer;
in response to receiving an indication of a selection of the hyperlink by the viewer,
causing a webpage to be loaded in a web browser of the user device,
wherein the content is accessible through the webpage, and
wherein the webpage includes scripting language codes that are configured to generate viewer activity data in response to detecting viewer interactions with the content;
receiving the viewer activity data from the user device,
wherein the activity data is uploaded by the user device using an application programming interface (API);
storing the viewer activity data in a database; and
calculating a confidence score based on the viewer activity data,
wherein the confidence score represents a likelihood that presentation of the content to the viewer will culminate in a sale of the product or the service described by the content.

2. The method of claim 1, wherein the API allows the viewer activity data to be automatically collected in near real time by the server.

3. The method of claim 1, further comprising:
estimating a timeframe based on the viewer activity data,
wherein the timeframe represents a time during which the sale of the product or the service is expected to occur.

4. The method of claim 1, wherein the viewer interactions include one or more of
a start time and an end time of viewing an element of the content;
a selection of an element of the content;
an order in which elements of the content are viewed; and
a minimization of the content from view.

5. The method of claim 1, wherein the content is hosted by a server accessible to the user device across a network.

6. The method of claim 5, wherein the content is hosted by the server in a proprietary file format as a series of slides.

7. The method of claim 7, wherein the viewer activity data is uploaded by the user device on a slide-by-slide basis.

8. A method comprising:
loading a webpage that includes business content in a web browser of a user device associated with a viewer,
wherein the webpage includes scripting language codes that are configured to generate viewer activity data in response to detecting viewer interactions with the business content;
receiving the viewer activity data from the user device;
continually monitoring the viewer activity data to detect the viewer interactions with the business content; and
analyzing the viewer interactions to predict an outcome from presenting the business content to the viewer.

9. The method of claim 8, wherein the scripting language codes are directly executable by the web browser.

10. The method of claim 8, wherein the business content includes a series of slides regarding a service or a product being pitched to the viewer by a sales representative.

11. The method of claim 10, further comprising:
applying the viewer activity data to one or more predictive models to measure a likelihood of finalizing a sale of the service or the product.

12. The method of claim 8, further comprising:
performing one or more classification algorithms using the viewer activity data to optimize business content shown to future viewers.

13. The method of claim 10, further comprising:
identifying a recommended action for closing a sale of the product or the service based on the outcome.

14. The method of claim 13, further comprising:
retrieving external data from a customer relationship management (CRM) system; and
calculating a confidence score based on the viewer activity data, the external data, or both,
wherein the confidence score represents a likelihood that presentation of the content to the viewer will culminate in a sale of the product or the service described by the content.

15. The method of claim 8, further comprising:
creating a hyperlink embedded with an address to the business content; and
sending the hyperlink to the user device via an electronic communication.

16. The method of claim 15, wherein the electronic communication is an email or a Short Messaging Service (SMS) message.

17. The method of claim 8, further comprising:
storing the activity data in a database in a structure implied by a structure of the business content.

18. A system comprising:
a processor; and
a memory coupled to the processor, the memory storing instructions that, when executed by the processor, cause the processor to:
continually retrieve viewer activity data from a user device of a viewer,
wherein the viewer activity data is generated by scripting language codes executed by the user device in response to detecting viewer interactions with content shared by a sales representative during an interaction;
analyze the viewer activity data to identify instances of viewer interactions with the content;
calculate a confidence score for the interaction between the sales representative and the viewer based on the viewer activity data;
modifying a sales forecast for the sales representative based on the confidence score for the interaction.

19. The system of claim 18, wherein the confidence score represents a likelihood that the interaction will culminate in a sale of a product or a service described by the content to the viewer.

20. The system of claim 18, wherein said continually retrieving is performed using an application programming interface that establishes a communication channel between the user device of the viewer and the system.
